(19) United States
(12) Patent Application Publication
(10) Pub. No.: US 2006/0077813 A1
(43) Pub. Date: Apr. 13, 2006

(54) Method and disc reading device for detecting unbalanced disc

(76) Inventors: Cheng-Chieh Chuang, Xihu Town (TW); Sung-Kun Wu, Taoyuan City (TW)

Correspondence Address: REED SMITH LLP;Suite 1400, 3110 Fairview Park Drive, Falls Church, VA, 22042, US

(21) Appl. No.: 11/216,068

(22) Filed: Sep. 1, 2005

(30) Foreign Application Priority Data
Sep. 3, 2004 (TW) 93126651

(51) Int. Cl. G11B 5/09

(52) U.S. Cl. 369/47.1; 369/53.1; 369/59.1

(57) ABSTRACT

A method and disc reading device for detecting an unbalanced disc are disclosed. The disc reading device includes a first sensor, a second sensor, a cache memory, an operating unit and a data table. The first sensor and the second sensor respectively detect a first parameter and a second parameter when the disc reading apparatus driving the disc at a predetermined voltage. When the first parameter is detected as being equal to a first predetermined value, the cache memory records the second parameter as a first corresponding value. When the second parameter is detected as being equal to a second predetermined value, the cache memory records the second parameter as a second corresponding value. The operating unit calculates a difference between the first and the second corresponding values to obtain the unbalance status.

### CROSS REFERENCE TO RELATED APPLICATIONS

This application claims priority of Taiwan Patent Application Serial No. 093126651 entitled “Method and Disc Reading Device for Detecting Unbalanced Disc”, filed on Sep. 3, 2004.

### FIELD OF THE INVENTION

The present invention relates to an apparatus and a method for detecting an unbalance status of a disc, and particularly to an apparatus and a method for detecting the unbalance status according to detected parameters.

### BACKGROUND OF THE INVENTION

For many years, digital technology is broadly used in many areas. Thus, the storage media for storing mass digital data is developed, such as CD-ROM, DVD-ROM and so on. Also, the rotation speed of the disc reading apparatus continuously increases for faster access speed. As a result, the problems with unbalance disc become more serious at high rotation speed.

Typically, for a slightly unbalanced disc, the mass center is not identical to the geometrical center. It is not remarkable if the unbalance is small or the rotation speed is low. As the rotation speed increases, the disc reading apparatus becomes vibrating and thus the data accessibility is affected. Further, the disc might be cracked, if the unbalance is serious, to cause damages to the disc reading apparatus.

In order to solve the above problem, the actual speed is typically lowered down while driving an unbalance disc. Hence, how to accurately determine unbalance disc is a very important issue.

Tracking Error Method is a conventional method for determining unbalance disc. This method uses reading head to detect the number of cross-track due to vibration caused by unbalance disc. As the disc vibration becomes more serious, the reading head detects more cross-tracks. However, the accuracy depends heaavily on the reading head and erroneous determination is common due to difference among different reading heads. Further, this method only detects the vibration in one direction, i.e. the radial direction, and is insensitive to the vibration in other directions.

Frequency Generator Method (FG method) is another conventional method for determining unbalance disc. In this method, the disc is pre-accelerated to a predetermined rotation speed, and the rotation speed is maintained at a substantial constant speed in close-loop condition for sampling the rotation speed in a time period ΔT. ΔT is divided into n Δt, n is a positive integer, and an average velocity Vi is calculated for each Δt. At last, ΣVi is calculated statistically to determine the unbalance amount. However, responsive to variation of disc speed, the motor needs to adjust maintaining the predetermined rotation speed because the system is required to be in close-loop condition. Moreover, FG method is not sensitive enough because the velocity variation is small in the close-loop condition.

As the above discussion, conventional methods have several problems, including erroneous determination, insensitivity, etc. It is advantageous to provide an apparatus and a method for accurately and easily detecting the unbalance status.

### SUMMARY OF THE INVENTION

It is one aspect of the invention to provide an apparatus and a method for easily and accurately detecting an unbalance status of a disc.

The present invention provides a disc reading apparatus for determining an unbalance status of a disc. The disc reading apparatus includes a first sensor, a second sensor, a cache memory, a calculating unit, and a data table. The first sensor detects a first parameter and the second sensor detects a second parameter when the disc reading apparatus drives the disc at a predetermined voltage. The cache memory records the detected second parameter as a first corresponding value when the first parameter is detected as being equal to a first predetermined value. The cache memory records the detected second parameter as a second corresponding value when the first parameter is detected as being equal to a second predetermined value. The data table has a standard difference corresponding to an unbalance-free disc and a plurality of reference differences respectively corresponding to a plurality of unbalanced discs. The calculating unit calculates a difference between the first corresponding value and the second corresponding value, and determines the unbalance status of the disc by comparing the calculated difference to the standard difference and the reference differences in the data table.

The present invention provides a method for determining an unbalance status of a disc disposed within a disc reading apparatus. The method includes the following steps. The disc reading apparatus is operated at a predetermined voltage for driving the disc. A first parameter and a second parameter are detected. The detected second parameter is recorded as a first corresponding value when the detected first parameter is equal to a first predetermined value. The detected second parameter is recorded as a second corresponding value when the detected first parameter is equal to a second predetermined value. A difference is calculated between the first corresponding value and the second corresponding value. The unbalance status of the disc is determined according to the difference.

### BRIEF DESCRIPTION OF THE DRAWINGS

FIG. 1 illustrates a disc reading apparatus in accordance with an embodiment of the present invention;

FIG. 2 illustrates a flowchart for detecting an unbalance status of a disc in accordance with another embodiment of the present invention;

FIG. 3A illustrates the parameters used in a detecting method at constant rotation speed;

FIG. 3B illustrates a data table according to the FIG. 3A;

FIG. 4A illustrates the parameters used in a detecting method at constant time period;

FIG. 4B illustrates a data table according to the FIG. 4A; and

FIG. 5 illustrates a data table in accordance with further another embodiment of the present invention.

### DETAILED DESCRIPTION OF THE INVENTION

<Unbalance Status of a Disc>

A disc is unbalanced when its mass center is not identical to its geometrical center. It causes following two effects: (1) increase of the moment of inertia; and (2) generation of lateral force on the rotation axle, thereby the friction force on motor is increased. These two effects are discussed as following:

(A) Increased Moment of Inertia

The moment of inertia, I₀, of a normal disc, i.e. an unbalance-free disc, is

$${I}_{0} = \frac{1}{2} m ( {r}_{0}^{2} - {r}_{1}^{2} ) ,$$

wherein m is mass of the disc, r₀ is outer radius of the disc, and r₁ is inner radius of the disc.

Given an unbalance disc with a offset mass m′ in addition to the normal mass m, the moment of inertia of the unbalance disc, I′, is described as following:

$${I}^{′} = \frac{1}{2} m ( {r}_{0}^{2} - {r}_{1}^{2} ) + {m}^{′} {x}^{2} ,$$

wherein x is offset radius.

In general, m′ is usually much smaller than m, i.e. m′<<m. Thus, the increased moment of inertia due to unbalance, i.e. m′x², is much smaller than the normal moment of inertia. That is, m′x² is negligible and I′ is substantially equal to I₀.

(B) Lateral Force on Rotation Axle

The lateral force, F, on the rotation axle during rotation of an unbalance disc is
F=mr ω²,

wherein m is the mass of disc, r is the radius of disc, and ω is the rotation speed of disc. Assuming the unbalance disc rotates at 175 Hz with typical 6 g-mm offset mass, the resulted lateral force is about 30 gw. The acceleration process is affected by the resulted lateral force, and thus the acceleration of an unbalance disc is distinguishable from that of a normal disc, which is the operation principle of the present invention.

<Operation Principle of Driving Device>

In one embodiment of the present invention, an optical disc reading device is embodied with a driving device to rotate the disc, wherein motor is commonly used as the driving device. When the driving device operates at a voltage V, the operation of driving device is described by Equation (1):

$$V = E + iR + L \frac{ⅆ i}{ⅆ t} . \qquad Equation ( 1 )$$

Wherein E is the power consumption of driving device, i is the applied current, R is the resistance of driving device, L is the inductance of driving device, and t represents time. Inductance L is negligible since it is relatively much smaller. The equation (1) is rewritten by substituting E=k_{N}N and i=τ/kₜ as Equation (2):

$$V = {k}_{N} N + \frac{τ}{{k}_{t}} R . \qquad Equation ( 2 )$$

Wherein k_{N} is a coefficient of rotation speed and kₜ is a resistance coefficient, both depend on the characteristics of driving device. N is the rotation speed of the driving device and τ is the torque of driving device. The torque τ of driving device is further described by:
τ=τ_{f}+Iα,

wherein τ_{f} is the friction torque, I is the moment of inertia, and α is the angular acceleration of rotation axle. Thus, the equation (2) is rewritten as Equation (3):

$$V = {k}_{N} N + \frac{( {τ}_{f} + I α )}{{k}_{t}} R . \qquad Equation ( 3 )$$

From the above equations, the torque τ outputted by the driving device should be a constant value at a certain rotation speed if the applied voltage remains unchanged. According to the above discussions, the moment of inertia of a normal disc is substantially equal to an unbalance disc, thus a large angular acceleration a results in a smaller friction torque τ_{f} and vice versa. Further reference to the above-mentioned lateral force on rotation axle, the lateral force on axle for an unbalance disc is greater than that of a normal disc, thus the torque τ_{f} of the unbalance disc is also greater than the normal disc. Therefore, the acceleration of an unbalance disc is smaller when the driving device operates at a constant voltage. Correspondingly, it requires more time to reach a predetermined speed for an unbalance disc.

While the above descriptions discuss about the relationship between acceleration and time, those who skilled in the art may also derive speed-time relationship via mathematical derivation.

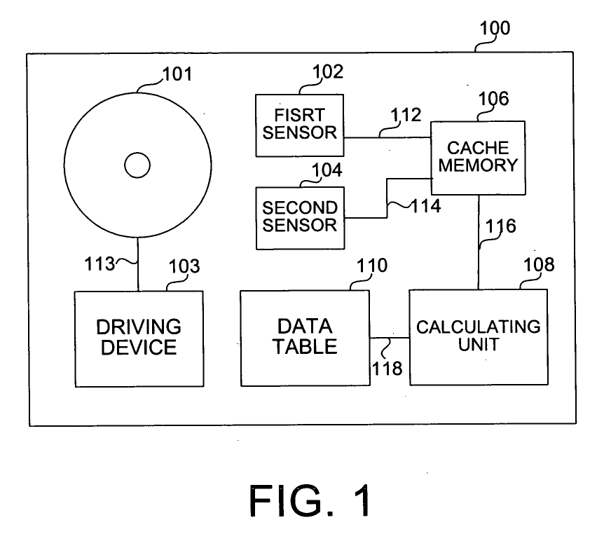

FIG. 1 shows a disc reading apparatus 100 in accordance with the embodiment of the present invention. As shown in FIG. 1, driving device 103 controls the rotation of disc 101 via a signal line 113, and the disc reading apparatus 100 may read the data stored on the disc 101. The disc reading apparatus 100 includes a first sensor 102, a second sensor 104, a cache memory 106, a calculating unit 108 and a data table 110. The first sensor 102 detects a first parameter, and the second sensor 104 detects a second parameter. The first parameter and the second parameter include time, rotation speed of the disc, acceleration of the disc, and the likes. For example, the first parameter is a rotation speed, and the second parameter is time. In this way, a rotation speed increment from a first time value to a second time value may be obtained, thus the unbalance status of the disc is determined. It should be noted that those skilled in the art may understand that other variables, such as acceleration and time, may be used as the first parameter and the second parameter respectively. The detailed for other examples are omitted here for conciseness.

The cache memory 106 connects to the first sensor 102 and the second sensor 104, respectively through signal lines 112 and 114, for selectively recording the first parameter and/or second parameter. The cache memory 106 may be any conventional storage unit, such as dynamic random access memory (DRAM), static random access memory (SRAM), or any other storage units. In this embodiment, the cache memory 106 records the second parameter, detected by second sensor 104 when the disc reading apparatus driving the disc at a predetermined voltage, as a first corresponding value when the first parameter, detected by the first sensor 102 when the disc reading apparatus driving the disc at a predetermined voltage, is equal to a first predetermined value. The cache memory 106 records the second parameter, detected by second sensor 104, as a second corresponding value when the first parameter, detected by first sensor 102, is equal to a second predetermined value. The first predetermined value and the second predetermined value is selected on demand without any particular limitation. The calculating unit 108 is connected to cache memory 106 through a signal line 116 for calculating a difference between the first corresponding value and the second corresponding value. The calculating unit 108 further determines a corresponding unbalance status of the disc from a data table 110. Data table 110 is connected to calculating unit 108 through a signal line 118. The data table 110 contains at least a standard difference, corresponding to an unbalance-free disc, and a plurality of reference differences, corresponding to a plurality of unbalanced discs. The details of data table 110 are described hereinafter.

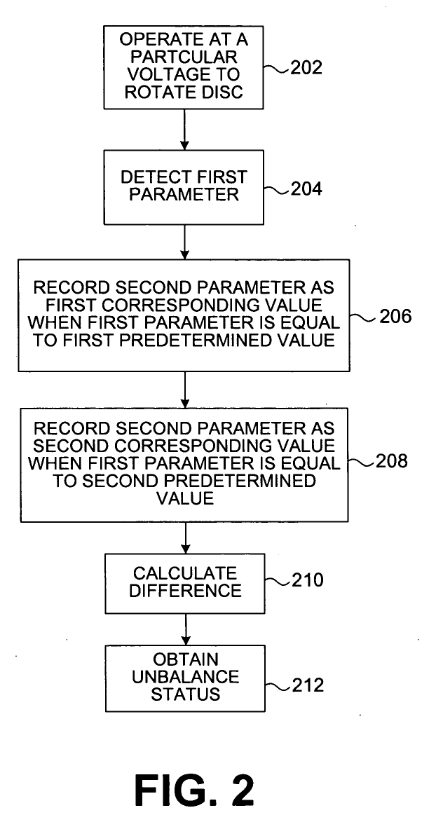

FIG. 2 shows a flowchart for detecting an unbalance status of a disc in accordance with another embodiment of the present invention. The method is used within a disc reading apparatus. In step 202, the disc reading apparatus operates at a particular voltage to rotate and accelerate the disc. In step 204, a first parameter and a second parameter are detected. In step 206, the detected second parameter is recorded as a first corresponding value when the detected first parameter is equal to a first predetermined value. In step 208, the detected second parameter is recorded as a second corresponding value when the detected first parameter is equal to a second predetermined value. The first predetermined value and the second predetermined value is selected on demand without any particular limitation. In step 210, a difference between the first corresponding value and the second corresponding value is calculated. In step 212, the unbalance status of the disc is obtained according to the difference.

As described above, the present invention provides a method and an apparatus for determining an unbalance statue of a disc. An accurate result may be obtained based on the fore-mentioned principles and discussions. It should be noted that although the disc reading apparatus is described above to operate at a particular voltage for rotating the disc from static condition, it does not intent to limit the present invention as such. Therefore, the present invention may be applied to any initial condition of the disc, such as a static disc or an already rotating disc, either accelerated in open-loop or closed loop conditions, or any other conditions. Moreover, the present invention may be used concurrently with the conventional detecting methods.

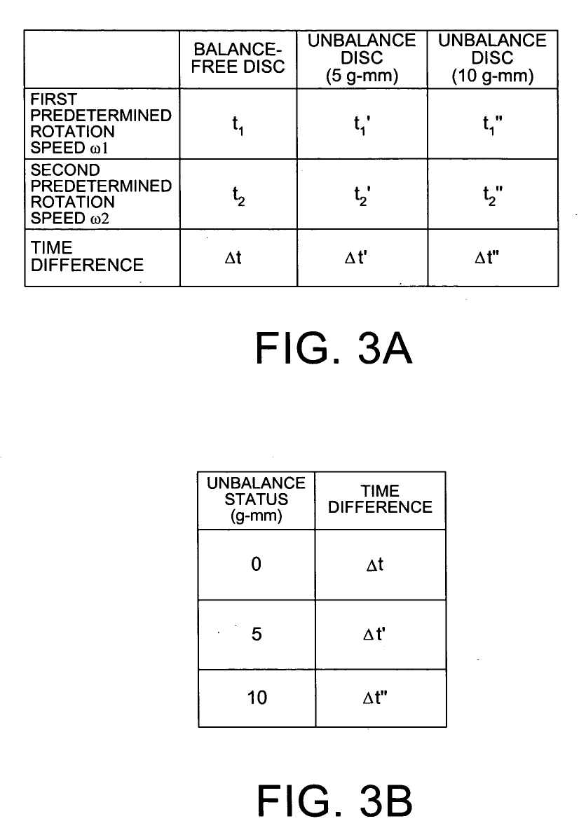

FIG. 3A illustrates the parameters used in a detecting method at constant rotation speed. In this embodiment, the unbalance status of disc is determined based on rotation speed-time relationship. That is, the rotation speed of the disc is selected as the first parameter and the rotation time is selected as the second parameter. As shown in FIG. 3A, the first column shows the recorded data corresponding to a normal disc, i.e. an unbalance-free disc. As above-mentioned, the apparatus operates at a particular voltage to rotate and accelerate the disc. When the rotation speed of disc increases to a first predetermined rotation speed (ω₁), a first corresponding time t₁ is recorded. When the rotation speed of disc further increases to a second predetermined rotation speed (ω₂), a second corresponding time t₂ is recorded. Further, a time difference Δt between t₁ and t₂ is calculated. The second column shows the recorded data corresponding to a predetermined 5 g-mm unbalanced disc. When the rotation speed of this unbalance disc increases to the first predetermined rotation speed (ω₁), a first corresponding time t₁′ is recorded. When the rotation speed of this unbalance disc further increases to a second predetermined rotation speed (ω₂), a second corresponding time t₂′ is recorded. A time difference Δt′ between t₁″ and t₂′ is calculated. Similarly, a first corresponding time t₁″, a second corresponding time t₂″, and a time difference Δt″ are obtained corresponding to a predetermined 10 g-mm unbalance disc. According to the above discussions, the relationship between these three time differences is Δt″>Δt′>Δt.

FIG. 3B illustrates a data table according to recorded data shown in FIG. 3A. The data table shown in FIG. 3B may be implemented in the disc reading apparatus of the present invention. Taking data table in FIG. 3B as an example, if a disc with unknown unbalance status is placed into the disc reading apparatus, the disc reading apparatus detects the first parameter (e.g. rotation speed) and the second parameter (e.g. time) and calculates the difference (e.g. time difference) according to the above-mentioned method. If the calculated difference is between Δt and Δt′, the disc is determined as a balance disc (or at most a slight unbalance disc). Hence, the disc reading apparatus reads data on this disc in fill speed. If the calculated difference is between Δt′ and Δt″, the disc is determined as a medium unbalanced disc. Hence, the disc reading apparatus reads data on this disc with reduced rotation speed. Furthermore, if the calculated difference is greater than Δt″, the disc is determined as a significant unbalance disc. Hence, the disc reading apparatus reads data on this disc in a lower or a minimum rotation speed for safety considerations. In this way, damage is prevented.

It should be noted that three predetermined statuses are recited here for explaining the present invention. Those skilled in the art should understand that other number of statuses may be used. The illustrated embodiments should be considered as examples and should not be construed in a limiting sense

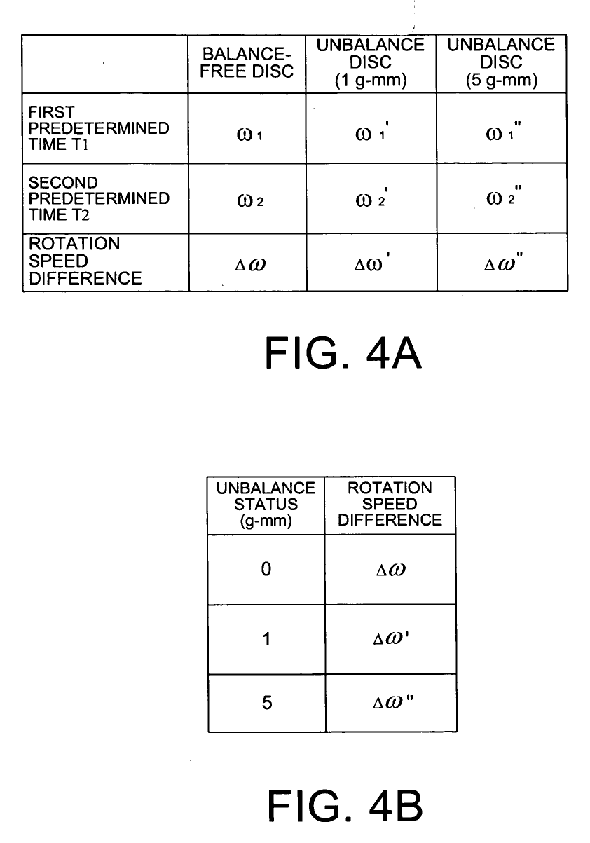

FIG. 4A illustrates the parameters used in a detecting method at constant time period. In this embodiment, the unbalance status of disc is determined based on time-rotation speed relationship. That is, the rotation time of the disc is selected as the first parameter and the rotation speed is selected as the second parameter. As shown in FIG. 4A, the first column shows the recorded data corresponding to a normal disc, i.e. an unbalance-free disc. As above mentioned, the apparatus operates at a particular voltage to rotate and accelerate the disc. When disc has rotated for a first predetermined time (t₁), a first corresponding rotation speed ω₁ is recorded. When disc further has rotated to a second predetermined time (t₂), a second corresponding rotation speed ω₂′ is recorded. Further, a rotation speed difference Δω′ between ω₁′ and ω₂ is calculated. The second column shows the recorded data corresponding to a predetermined 1 g-mm unbalanced disc. When a first predetermined time (t₁) is reached, a first corresponding rotation speed ω₁′ is recorded. When the rotation time of this unbalance disc is at a second predetermined time (t₂), a second corresponding rotation speed ω₂′ is recorded. A time difference Δω′ between ω₁′ and ω₂′ is calculated. Similarly, a first corresponding rotation speed ω₁″, a second corresponding rotation speed ω₂″, and a rotation speed difference Δω″ are obtained corresponding to a predetermined 5 g-mm unbalance disc. According to the above discussions, the relationship between these three rotation speed differences is Δω″<Δω′<Δω.

FIG. 4B illustrates a data table according to the FIG. 4A. The data table is used in the disc reading apparatus for determining unbalance status of a disc. Taking data table in FIG. 4B as an example, as a disc with unknown unbalance status is placed into the disc reading apparatus, the disc reading apparatus detects the first parameter (e.g. time) and the second parameter (e.g. rotation speed) and calculates the difference (e.g. rotation speed difference) according to the above-mentioned method. If the calculated difference is between Δω and Δω′, between Δω″ and Δω″, or below Δω″, the disc is respectively determined as a balance disc (or at most a slight unbalance disc), a medium unbalanced disc, or a significant unbalance disc. Hence, the disc reading apparatus respectively reads data on the disc in appropriate speed.

It should be note that the determination of balance disc described above is illustrated as an example. In another embodiment, the data table may be utilized in different manner. For example, the unbalance status of disc may be determined by interpolation, extrapolation, or other conventional manner. Furthermore, relationship between angular acceleration and time may also be alternatively used to determine the unbalance status of disc.

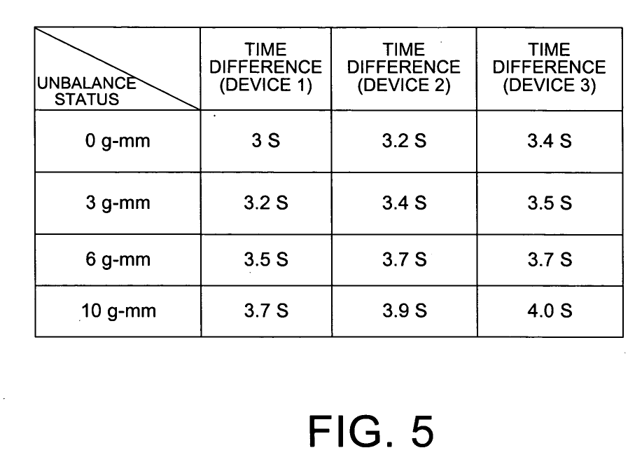

FIG. 5 illustrates an alternative data table of the present invention. In this data table, it contains data for three different devices, e.g. different models. Each device is tested for measuring its own data. In other embodiment, data table may be obtained from statistically categorizes the disc reading apparatuses into certain types. When a disc reading apparatus is produced, a specific functional test may be performed first, and then appropriate type for the data table is determined. For example, if a disc reading apparatus operates with a normal disc, and the time difference is determined as 3.2 seconds. Thus, this apparatus is categorized as the second type device according to FIG. 5. And the data corresponding to second type are stored in this apparatus. In this way, accuracy for determining unbalance status is increased. Moreover, interpolation, extrapolation, or other conventional manner may be used during the production and use of data in FIG. 5 for further accuracy.

The spirit and scope of the present invention can be clearly understood by the above detail descriptions of the prefer embodiments. The embodiments are not intended to construe the scope of the invention. Contrarily, various modifications of the illustrative embodiment, as well as other embodiments of the invention, will be apparent to persons skilled in the art upon reference to this description. It is therefore contemplated that the appended claims will cover any such modifications or embodiments as falling within the true scope of the invention.

What is claimed is:

1. A method for determining an unbalance status of a disc disposed within a disc reading apparatus, the method comprising:
operating the disc reading apparatus at a predetermined voltage for driving the disc;
detecting a first parameter and a second parameter;
recording the detected second parameter as a first corresponding value when the detected first parameter is equal to a first predetermined value;
recording the detected second parameter as a second corresponding value when the detected first parameter is equal to a second predetermined value;
calculating a difference between the first corresponding value and the second corresponding value;
determining the unbalance status of the disc according to the difference.

2. The method according to claim 1, wherein the first parameter represents a time value and the second parameter represents a rotation speed of the disc.

3. The method according to claim 1, wherein the first parameter represents a time value and the second parameter represents an acceleration of the disc.

4. The method according to claim 1, wherein the first parameter represents a rotation speed of the disc and the second parameter represents a time value.

5. The method according to claim 1, wherein the first parameter represents an acceleration of the disc and the second parameter represents a time value.

6. The method according to claim 1, wherein the disc reading apparatus further includes a data table, the data table having a standard difference corresponding to an unbalance-free disc and a plurality of reference differences respectively corresponding to a plurality of unbalanced discs, the method further comprising comparing the calculated difference to the standard difference and the reference differences in the data table.

7. A disc reading apparatus for determining an unbalance status of a disc, the disc reading apparatus comprising:
a first sensor for detecting a first parameter when the disc reading apparatus driving the disc at a predetermined voltage;
a second sensor for detecting a second parameter when the disc reading apparatus driving the disc at the predetermined voltage
a cache memory for recording the detected second parameter as a first corresponding value when the first parameter is detected as being equal to a first predetermined value, and for recording the detected second parameter as a second corresponding value when the first parameter is detected as being equal to a second predetermined value;
a data table having a standard difference corresponding to an unbalance-free disc and a plurality of reference differences respectively corresponding to a plurality of unbalanced discs; and
a calculating unit for calculating a difference between the first corresponding value and the second corresponding value and determining the unbalance status of the disc by comparing the calculated difference to the standard difference and the reference differences in the data table.

8. The apparatus according to claim 7, wherein the first parameter represents a time value and the second parameter represents a rotation speed of the disc.

9. The apparatus according to claim 7, wherein the first parameter represents a time value and the second parameter represents an acceleration of the disc.

10. The apparatus according to claim 7, wherein the first parameter represents a rotation speed of the disc and the second parameter represents a time value.

11. The apparatus according to claim 7, wherein the first parameter represents an acceleration of the disc and the second parameter represents a time value.
